(19) United States
(12) Patent Application Publication
(10) Pub. No.: US 2026/0334371 A1
(43) Pub. Date: Oct. 29, 2026

(54) Device for Processing Cut Grain Mass in a Harvesting Machine

(71) Applicant: Zharylkasyn Sadykov, Almaty (KZ)

(72) Inventors: Zharylkasyn Sadykov, Almaty (KZ); Elizaveta Makasheva, Almaty (KZ); Artem Rodin, Balakhna (RU); Semyon Bolotnikov, Almaty (KZ); Meirambay Toylybaev, Almaty (KZ); Bakhyt KOKEBAYEV, Almaty (KZ); Ondassyn ABDUALI, Almaty (KZ)

(21) Appl. No.: 19/430,666

(22) Filed: Dec. 23, 2025

(30) Foreign Application Priority Data
Apr. 28, 2025 (KZ) 2025/0399.1

(51) Int. Cl. A01F 12/46

(52) U.S. Cl. CPC A01F 12/46

(57) ABSTRACT

The invention relates to agricultural engineering, specifically to a device for processing grain mass in a harvesting machine, such as a grain combine or a combine for harvesting grass seeds and other agricultural crops. It can also be used for harvesting cereals, legumes, forage, oilseed, technical crops, and the productive parts of medicinal plants.

In the device for processing cut grain mass in a harvesting machine, which includes an inclined chamber with a bottom on which active elements for moving the grain mass are fixed, and a conveyor, according to the invention, the active elements have a curvilinear profile: one edge has a height of 15-70 mm, while the other edge gradually tapers to zero. The active elements are mounted on bases and installed in box-shaped holders with three walls—two side walls and one end wall. The height of the walls does not exceed the lower level of the active element. At the inlet end of the holder, a clamp is installed in one of the side walls to fix the base of the active element, while the opposite side wall of the holder has a longitudinal flange along the length of its upper edge, turned inward to secure the edge of the active element under the flange. The free end of the active element bases has a streamlined shape, and the holders are rigidly fixed to the bottom of the inclined chamber.

The proposed device, with removable active elements securely fixed to the bottom of the inclined chamber in holders, ensures the possibility of their quick replacement without replacing the chamber bottom and also helps reduce the metal consumption of the device.

### CROSS REFERENCE TO RELATED APPLICATIONS

This application claims the benefit of priority of Kazakhstan Patent Application No. 2025/0399.1, filed Apr. 24, 2025, the contents of which are all incorporated herein by reference in their entirety.

The invention relates to agricultural engineering, specifically to a device for processing grain mass in a harvesting machine, such as a grain combine or a combine for harvesting grass seeds and other agricultural crops. The invention can be used when harvesting cereals, legumes, forage crops, oilseeds, technical crops, and the productive parts of medicinal plants. In addition, the invention can be used when harvesting corn for silage, root crops, and other crops where it is necessary to level the collected mass inside the harvesting machine.

A known device for processing cut grain mass in a harvesting machine includes an inclined chamber with a bottom that has a working surface for moving the cut mass, a chute for collecting separated grain and feeding it into a grain tank, a conveyor with transverse slats on a belt, and a grain tank for collecting and removing separated grain. The working surface of the bottom of the inclined chamber is corrugated, with corrugations-active elements-having a W- and V-shaped profile made from bent equal-angle metal angles and arranged on the working surface of the bottom in the form of branches. In the receiving zone of the conveyor, the inclined chamber contains a removable perforated separating grate connected to the grain tank (Patent EAPO No. 002420, Class A01D41/00, A01D41/12, A01D45/30). This is the prototype.

The disadvantage of the device is the low efficiency of replacing active elements that experience the greatest loads when the grain mass flow enters, since replacing them requires changing the bottom of the inclined chamber, which causes downtime and increases harvesting time. In addition, the device has high metal consumption because the active elements—corrugations with W- and V-shaped profiles—are made of metal angles.

The objective and technical result of the proposed invention is to develop a device with active elements securely fixed to the bottom of the inclined chamber while ensuring their removability, quick replacement without replacing the chamber bottom, and reducing the metal consumption of the device.

To achieve this technical result, in the device for processing cut grain mass in a harvesting machine, which includes an inclined chamber with a bottom on which active elements for moving the grain mass are fixed, and a conveyor, according to the invention, the active elements have a curvilinear profile, with one edge having a height of 15-70 mm, and the other edge tapering to zero. The active elements are mounted on bases and installed in box-shaped holders with three walls—two side walls and one end wall—the height of the walls does not exceed the lower level of the active element. In one of the side walls at the entry end of the holder, a clamp is installed to fix the base of the active element, while the opposite side wall of the holder has a flange along the length of its upper edge, turned inward to secure the edge of the active element under the flange. The free end of the bases of the active elements has a streamlined shape, and the holders are rigidly fixed to the bottom of the inclined chamber.

In the device, the active elements in the holders are installed on the bottom of the inclined chamber in a “herringbone” pattern with the apex directed toward the receiving chamber of the harvesting machine.

In the device, the active elements in the holders are installed on the bottom of the inclined chamber in a “herringbone” pattern with the apex directed toward the threshing-separating unit of the harvesting machine.

In the device, the active elements on the bases are manufactured using a 3D printer.

The drawings show the proposed device for processing cut grain mass in a harvesting machine:

FIG. 1—general view of part of the harvesting machine, including the inclined chamber;

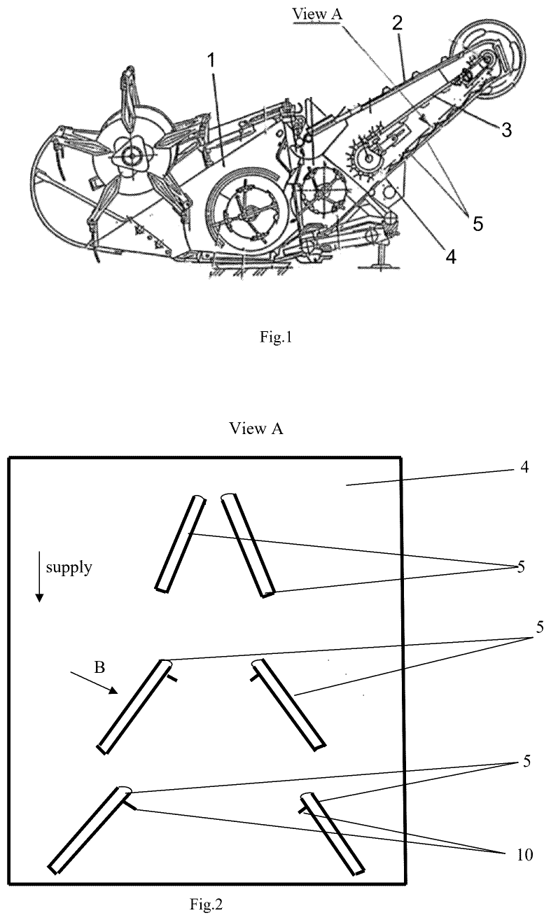

FIG. 2—active elements in holders installed in a “herringbone” pattern with the apex directed toward the receiving chamber of the harvesting machine, view A in FIG. 1;

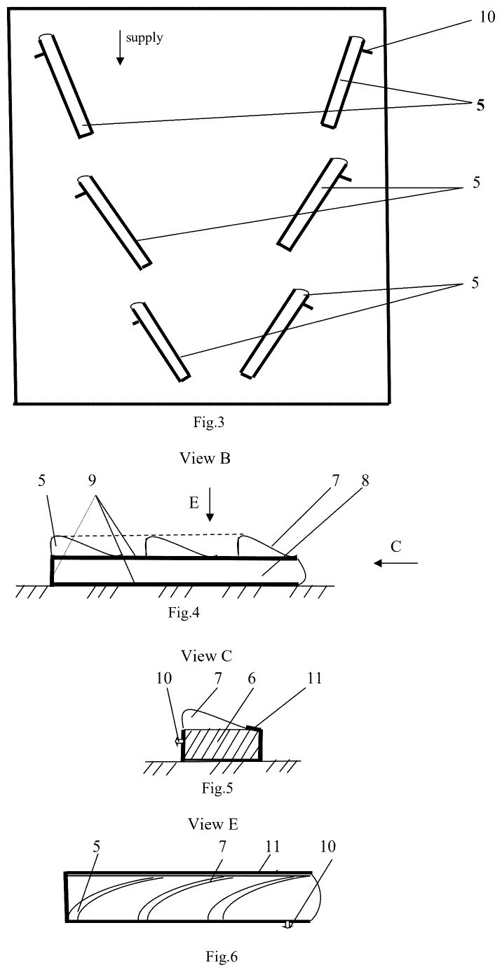

FIG. 3—active elements in holders installed in a “herringbone” pattern with the apex directed toward the threshing-separating unit of the harvesting machine;

FIG. 4—active element with a curvilinear profile installed in a holder, view B in FIG. 2;

FIG. 5—active element on a base installed in a holder, view C in FIG. 4;

FIG. 6—active element with a curvilinear profile installed in a holder, view E in FIG. 4.

The proposed device includes a header (1), an inclined chamber (2) located in the harvesting machine, such as a grain combine, in which a conveyor (3) is installed. The inclined chamber has a bottom (4) on which active elements (5) are mounted on bases (6). The free end of the bases (6) of the active elements has a streamlined shape to improve the movement of the grain mass (FIG. 5). The active elements (5) have a curvilinear profile (7). One edge of the active elements (5) has a height of 15-70 mm, while the other edge tapers to zero. The active elements (5), mounted on bases (6), are installed in box-shaped holders (8) with three walls (9)—two side walls and one end wall—the height of the walls (9) does not exceed the lower level of the active element (5). In one of the side walls (9) at the entry end of the holder (8), a clamp (10) is installed to fix the base (6) of the active element (5) (FIG. 5). The opposite side wall (9) of the holder (8) has a flange (11) along the length of its upper edge, turned inward to secure the edge of the active element under the flange (FIG. 5).

The active elements (5) on the bottom (4) can be installed in a “herringbone” pattern with the apex directed toward the receiving chamber of the harvesting machine, as shown in FIG. 2, or with the apex directed toward the threshing-separating unit of the harvesting machine, as shown in FIG. 3.

The drawings indicate the following structural elements:
1—header
2—inclined chamber
3—conveyor
4—bottom
5—active element
6—base of the active element
7—curvilinear profile of the active element
8—box-shaped holder
9—walls of the holder
10—clamp
11—flange of the holder

Installing curvilinear-profile active elements on bases made with a 3D printer, placed in box-shaped holders fixed on both sides, with the ability to quickly remove them through the open end of the holder, allows for quick installation or replacement of a worn-out active element. Unlike the prototype device, there is no need for a complex procedure to replace the bottom. The box-shaped holders securely retain the active elements on bases on the bottom of the inclined chamber.

Manufacturing active elements with bases using a 3D printer significantly simplifies the ability to have the required number of these components available, ensuring a set of replaceable active elements for minimal replacement time.

The curvilinear profile of the active elements ensures that when the grain mass enters, it is shifted and leveled, preventing quantitative and qualitative grain losses. At the same time, quick and efficient removal of the component from the holder walls is ensured by loosening the clamp, such as a set screw. In the proposed invention, having holders in the form of a box with three walls rigidly fixed to the bottom of the inclined chamber and arranged in a “herringbone” pattern significantly speeds up the replacement of active components under small-scale farming conditions. Using active elements as modules on bases made with a 3D printer from powder, compared to prototype active elements made from metal angles, reduces the metal consumption of the device.

The disadvantage of the prototype device is the low efficiency of replacing corrugated active elements (grain mass levelers), which causes downtime and increases harvesting time. With prolonged harvesting beyond the recommended agro-term, the gross grain yield per hectare decreases, and the gap between biological and actual yield significantly increases. Due to untimely and quality harvesting, more than 20% of the grown crop is lost. These factors affect not only the quantity of seeds obtained but also their sowing and yield properties. As a result, there is an under-harvest of more than 3 centners per hectare, a decrease in seed (grain) quality and processed products (seed quality, oil content, sugar content, feed quality for animals, and others). Furthermore, the implementation of the device is closely related to the tasks of the harvesting period and directly follows from the formulation and methods of solving each task. For example, an intelligent recommendation service for variable ripeness recognition and minimizing quantitative and qualitative losses when harvesting cereals, legumes, forage crops, oilseeds, and technical crops in small-scale farming will require more frequent replacement of active elements than in medium- or large-scale production.

The proposed device operates as follows: The cut grain mass from the header (1) of the harvesting machine enters the inclined chamber (2), where, using the chain-slat conveyor (3) and the active elements (5) installed on the bottom (4), additional leveling, shifting, and feeding of the mass in a thin layer are performed.

When the type of harvested crop changes frequently, quick replacement of active elements (5) from the holder (8) is carried out by loosening the clamp (10), such as a set screw, and pushing the elements out of the holder walls. Then, a new active element (5) on a base (6) with the appropriate curvilinear profile parameters (7) is installed in the holder, inserted under the flange (11), and secured with the set screw (10).

When the active elements (5, 6) are installed on the working surface of the bottom (4) of the inclined chamber (2) in a “herringbone” pattern with the apex directed toward the receiving chamber of the harvesting machine, active lateral shifting of the grain mass from the center of the entry part to the side edges occurs, ensuring leveling and compression using the curvilinear surfaces (7), separation of released grain, and distribution of its feed into the threshing-separating unit of the harvesting machine.

When the active elements (5, 6) are installed on the working surface of the bottom (4) of the inclined chamber (2) with the apex directed toward the threshing-separating unit of the harvesting machine, active lateral shifting from the side edges of the entry part to the center of the exit part of the inclined chamber (2) occurs, ensuring leveling and compression using the curvilinear surfaces (7), separation of released grain, and distribution and transportation of the mass fed into the threshing-separating unit of the harvesting machine.

In this case, the active elements (5) with bases (6) and curvilinear surfaces (7), installed in holders (8) and securely fixed to the bottom (4) of the inclined chamber (2) while ensuring their removability and quick replacement without replacing the chamber bottom (4), should reduce the density of the grain mass at the edges and also reduce the thickness of the layer fed into the threshing unit.

In the separate harvesting method, the pickup auger of the harvesting machine (1) feeds the grain mass into the inclined chamber (2) as a flow maximally compressed in the middle. In this method, the active elements (5) must solve the opposite task-shift the excess flow from the middle part to the sides of the inclined chamber (2). To accomplish this task, the components (5, 6) must be fixed in the inclined chamber (2) so that the curvilinear profiles (7) are inclined toward the sides.

In any case, whether in direct or separate harvesting, the active elements (5) must level the grain mass flow. Furthermore, the interaction of the moving mass with the curvilinear profile (7) can contribute to partial threshing and, consequently, improve separation and reduce breakage in the threshing-separating unit of the harvesting machine.

The proposed device for processing cut grain mass in a harvesting machine provides the following advantages and benefits:
Ensure quick replacement of active components;
Reduce downtime and achieve higher yields;
Significantly reduce manual labor;
Increase grain harvesting productivity and threshing quality through efficient feeding of a thin layer of grain mass;
The device in the inclined chamber is more effective in high-performance combines (5-6 kg/s and above);
Reduce costs (lower production cost for a batch);
Allow students of engineering, agronomy, and other agricultural specialties to learn and apply modern 3D printing technology to solve problems in the agro-industrial complex.

1. Device for processing cut grain mass in a harvesting machine, comprising an inclined chamber with a bottom on which active elements for moving the grain mass are mounted, and a conveyor, characterized in that the active elements have a curvilinear profile, with one edge having a height of 15-70 mm, and the other edge tapering to zero along the arc of the element. The active elements are made on bases and installed in box-shaped holders with three walls: two side walls and one end wall. The height of the walls does not exceed the lower level of the active element. In one of the side walls at the input end of the holder, a clamp is installed for fixing the base of the active element, while the opposite side wall of the holder is provided with a longitudinal flange along the length of its upper edge, bent inward to secure the edge of the active element that goes under the flange. The free end of the bases of the active elements has a streamlined shape, and the holders are rigidly fixed to the bottom of the inclined chamber.

2. The device according to claim 1, characterized in that the active elements in the holders are arranged on the working surface of the bottom of the inclined chamber in a “herringbone” pattern with the apex directed toward the receiving chamber of the harvesting machine.

3. The device according to claim 1, characterized in that the active elements in the holders are arranged on the working surface of the bottom of the inclined chamber in a “herringbone” pattern with the apex directed toward the threshing and separating unit of the harvesting machine.

4. The device according to claim 1, characterized in that the active elements on the bases are manufactured using a 3D printer.
